(19) United States
(12) Patent Application Publication
(10) Pub. No.: US 2009/0141953 A1
(43) Pub. Date: Jun. 4, 2009

(54) IMAGING SYSTEM

(75) Inventors: Oliver Gerard, Viroflay (FR); Chuan Zheng, Bedford, MA (US); Pascal Allain, Versailles (FR); Damien Jean-Jacques Dolimier, Orleans (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,000

(22) PCT Filed: Jul. 13, 2005
(86) PCT No.: PCT/IB05/52324

§ 371 Date: Jan. 31, 2007

(30) Foreign Application Priority Data
Aug. 5, 2004 (US) 60 599 091

(51) Int. Cl. G06K 9/00

(52) U.S. Cl. 382/128

(57) ABSTRACT

The present invention relates to an imaging system for displaying image data representative of a structure. The imaging system comprises display rendering means for processing data representative of the configuration of the structure and rendering a display representative of the configuration of the structure. The display comprises image view panes displaying different image views. The rendering means are responsive to user interaction to display synchronously a predetermined sequence run of images at the view panes, in response to a user input stimulus.

### FIELD OF THE INVENTION

The present invention relates to an imaging system, and particularly but not solely to a system for use in medical applications.

### BACKGROUND OF THE INVENTION

Investigation of the structure of internal organs or other structures using medical imaging techniques is well known. Such techniques include, inter alia, Ultrasound scanning, CT and MRI. Exemplary ultrasound techniques are disclosed in for example WO/2004049952.

An improved modality of visualisation has now been devised.

### SUMMARY OF THE INVENTION

It is an object of the invention to provide a modality of visualisation enabling an observer to observe an image display providing useful technical understanding of the configuration of the structure, with minimal interaction with, and distraction for the user.

According to a first aspect, the present invention provides an imaging system for displaying image data representative of a structure, the imaging system comprising display rendering means for processing data representative of the configuration of the structure and rendering a display representative of the configuration of the structure, the display comprising image view panes displaying different image views, the rendering means being responsive to user interaction to display synchronously a predetermined sequence run of images at the view panes, in response to a user input stimulus.

The invention provides that with a simple user interaction (for example a single mouse click or key press), the observer witnesses automatic review of the predetermined sequence of images at the panes. The sequence of images could be a complete revolution of a 3D image at one pane about an axis (for example the long axis).

This has a benefit that the observer is caused to review more of the structure than he may otherwise choose to. Additionally, the observer is not distracted by having to operate an input device (such as a mouse or Keyboard) other than to input the initial stimulus. The requirement, for example, to move and click a mouse to move the 3D image is dispensed with. The system may operate such that in response to the user input stimulus the predetermined sequence run of images is played either on a loop or to a conclusion, unless a further user input stimulus occurs.

The predetermined sequence run of images for the panes are preferably run concurrently, as this aids in observer interpretation of the images. Beneficially the sequence runs initiate and terminate substantially concurrently, because this also aids in observer interpretation of the images.

The speed (for example frame rate) at which the image sequences are run is preferably predetermined for the run. The speed may be preselected by the observer prior to initiation of the sequence run.

Desirably, at least one of the view panes displays a 3D image of the structure. If panes display 2D images it is desirable that views are displayed from orthogonal viewpoints with respect to the structure. Beneficially, separate view panes display;
i) a 3D image of the structure;
ii) a first 2D image of the structure; and,
iii) a second 2D image of the structure,
wherein the first and second 2D images are obtained from viewpoints which are orthogonal with respect to the structure and which are superposed with computer generated borders of the structure corresponding to each 2D image.

The image rendering means is preferably responsive to user interaction to display synchronously a predetermined sequence run of images at each of the view panes, in response to a single user input stimulus, including concurrent rotation of the 3D image about an axis and an image sequence representative of translation along the axis at a 2D image pane.

The system may include means for acquiring the image data representative of the structure. In one embodiment the system may include ultrasound apparatus for acquiring the image data.

According to a further aspect, the present invention provides a method of rendering image data representative of a structure, the method comprising processing data representative of the configuration of the structure and rendering a display comprising image view panes displaying different image views, a user interaction stimulus triggering a synchronous predetermined sequence run of images at the view panes.

According to a further aspect, the invention provides a method of imaging a structure comprising rendering a display comprising image view panes displaying different image views, a user interaction stimulus triggering a synchronous predetermined sequence run of images at the view panes.

According to a further aspect, the invention provides a computer program product comprising a set of instructions enabling performance of the method.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is an exemplary view of an imaging system display according to the present invention,

FIG. 2 is a schematic representation of an ellipsoid illustrating a long and short axis, provided for purposes of explanation,

FIG. 3 is a schematic representation of the data acquisition system.

### DETAILED DESCRIPTION OF THE INVENTION

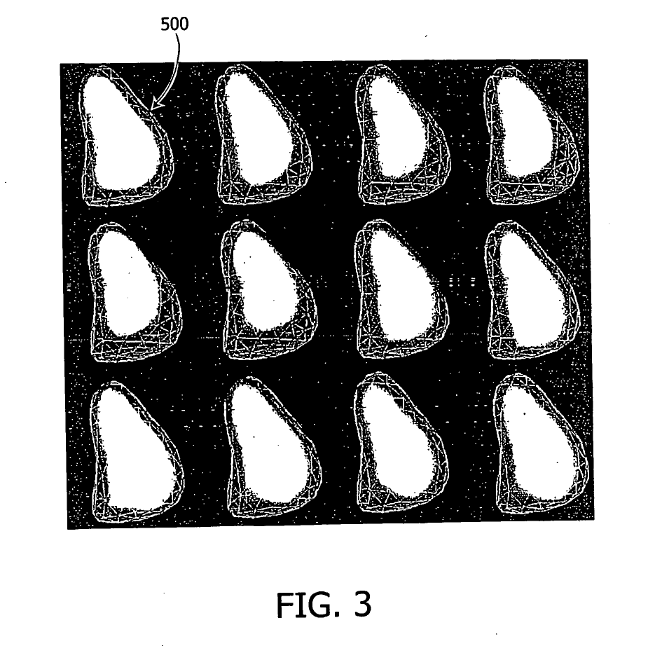

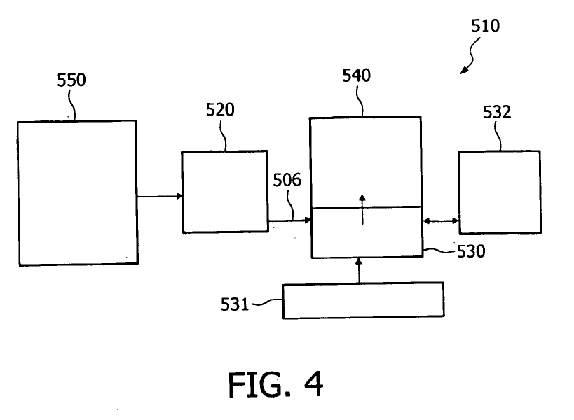

In accordance with the present invention and referring to FIG. 3, data acquisition may be accomplished via a 3D echocardiography examination system, comprising means for acquiring 3D volume digital data, and is associated with a digital processing system for processing the acquired 3D volume data. The examination system 550 shown in FIG. 3 comprises means for providing image data to the processing system which has at least one output 506 to provide image data to display and/or storage means 530,540. The display and storage means may respectively be the screen and memory of a workstation 510. The workstation 510 may also comprise a keyboard 531 and a mouse 532.

The image processing system 520 may be a suitably programmed computer of a workstation 510, or a special purpose processor having circuit means such as filters, logic operators and memories, that are arranged to perform the functions of the method steps according to the invention. The processing system 520 may use a computer program product having program instructions to be executed by the computing means of the processing system 520 in order to carry out the method steps. The data processing system, display and/or storage means may be located remotely from the data acquisition means of the system.

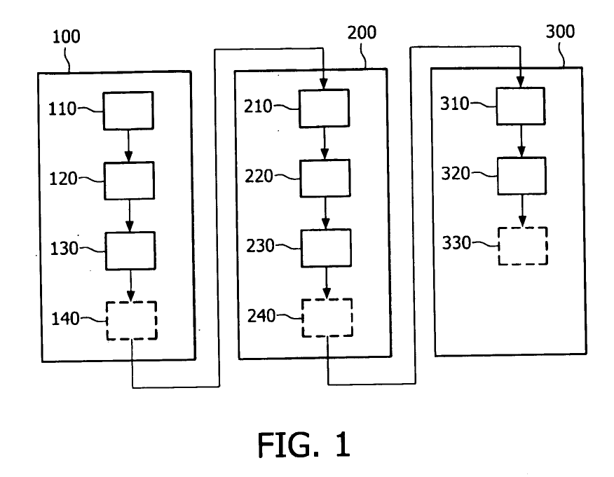

Following the data acquisition stage, the 3D volume data is processed to generate a border to highlight the position of inner periphery of the LV. FIG. 1 shows a series of panes 30, 40, 50 displaying 2D ultrasound images of, in this instance, the left ventricle LV. In addition, each image is superposed with the computer generated 2D cross-sectional border of the LV corresponding to the same plane in which the ultrasound image was acquired.

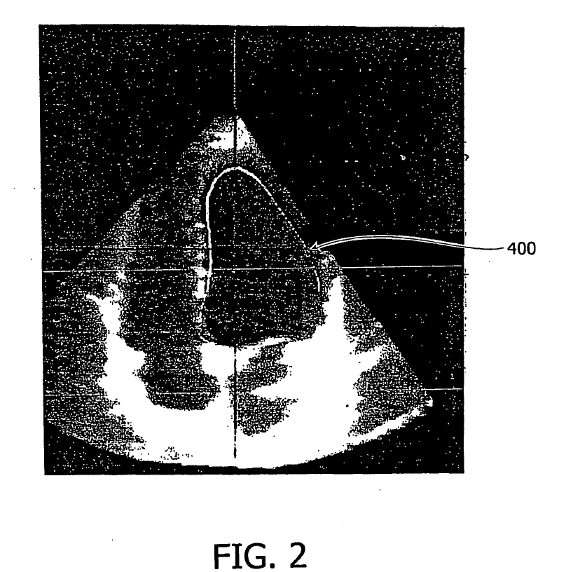

Pane 30 of the display of FIG. 1 shows the superposition of the cross-sectional image through the short axis 10 (as defined in FIG. 2) of the LV with the generated border, at a given position along its long axis 20 (as defined in FIG. 2). Similarly, panes 40 show the superposition of cross-sectional images through the long axis 20 of the LV with the computer generated border, at a given position along its short axis 10. Pane 50 shows the image of the LV constructed from the 3D volume data obtained during the acquisition stage.

The data review is initiated by a single mouse click or key press, whereupon the acquired 3D view 50, the cross-sectional image and border 40 through the long axis 20 and the cross-sectional image and border 30 through the short axis 10, rotate about the long axis 20 of the LV synchronously, at a pre-selected speed. During the rotation, the cross-sectional image and border 30 through the short axis 10 is simultaneously translated along the long axis 20. This visualisation technique allows any section of the LV to be viewed in several display orientations and if necessary the review can be stopped at a given viewpoint by a second single mouse click or key press. In this manner the user can simultaneously review the structure from several perspectives without suffering the distractions inherent to manually operated reviews.

Furthermore, the simultaneous display of the computer generated border with the corresponding 2D ultrasound image during the automated review, provides a means of data validation, through the consideration of the match of the generated border with the greyscale.

In addition, the reconstructed data is also amenable for any subsequent analysis of the LV, in which particular information such as ventricular volume is required.

It should be understood and appreciated that whilst an ultrasound imaging technique has been primarily described, the invention can be used to manipulate and display image data obtained using other techniques such as for example Magnetic Resonance Imaging (MRI) or Computed Tomography (CT).

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An imaging system for displaying image data representative of a structure, the imaging system comprising display rendering means for processing data representative of the configuration of the structure and rendering a display representative of the configuration of the structure, the display comprising image view panes displaying different image views, the rendering means being responsive to user interaction to display synchronously a predetermined sequence run of images at the view panes, in response to a user input stimulus.

2. An imaging system according to claim 1, wherein in response to the user input stimulus the predetermined sequence run of images is played either on a loop or to a conclusion, unless a further user input stimulus occurs.

3. An imaging system according to claim 1, wherein the predetermined sequence run of images represents a full rotation of the structure about an axis and/or a sequence of 2D slice images through the structure along a given axis.

4. An imaging system according to claim 1, wherein at least one of the view panes displays a 3D image of the structure.

5. An imaging system according to claim 1, wherein the view panes display image views of the structure from orthogonal viewpoints with respect to the structure.

6. An imaging system according to claim 1, wherein separate view panes display;
i) a 3D image of the structure;
ii) a first 2D image of the structure; and,
iii) a second 2D image of the structure,
wherein the first and second 2D image views are obtained from viewpoints which are orthogonal with respect to the structure and which are superposed with computer generated borders of the structure corresponding to each 2D image.

7. An imaging system according to claim 6, wherein the image rendering means is responsive to user interaction to display synchronously a predetermined sequence run of images at each of the view panes, in response to a user input stimulus.

8. An imaging system according to claim 1, wherein the predetermined sequence run of images for the panes are run concurrently.

9. An imaging system according to claim 1 wherein the speed at which the image sequences are run is predetermined.

10. An imaging system according to claim 1, wherein the user input stimulus is via an electronic device.

11. An imaging system according to claim 1, wherein the structure represents an organ or other structure (or a part thereof) internally of a human or animal body.

12. An imaging system according to claim 1, wherein the image represents the boundary of the structure.

13. An imaging system according to claim 1, including means for acquiring the image data representative of the structure.

14. An imaging system according to claim 13, including ultrasound apparatus for acquiring the image data.

15. A method of rendering image data representative of a structure, the method comprising processing data representative of the configuration of the structure and rendering a display comprising image view panes displaying different image views, a user interaction stimulus triggering a synchronous predetermined sequence run of images at the view panes.

16. A method of imaging a structure comprising rendering a display comprising image view panes displaying different image views, a user interaction stimulus triggering a synchronous predetermined sequence run of images at the view panes.

17. A computer program product comprising a set of instructions for carrying out a method according to claim 15.
